(19) United States
(12) Patent Application Publication
(10) Pub. No.: US 2022/0312557 A1
(43) Pub. Date: Sep. 29, 2022

(54) METHOD FOR OPERATING A MICROWAVE DEVICE

(71) Applicant: ELECTROLUX APPLIANCES AKTIEBOLAG, Stockholm (SE)

(72) Inventor: Andrea DE ANGELIS, Porcia (IT)

(21) Appl. No.: 17/641,483

(22) PCT Filed: Aug. 17, 2020
(86) PCT No.: PCT/EP2020/073021

§ 371 Date: Mar. 9, 2022

(30) Foreign Application Priority Data
Sep. 10, 2019 (EP) 19196390.9

(51) Int. Cl. H05B 6/68; H05B 6/70

(52) U.S. Cl. CPC H05B 6/686; H05B 6/705

(57) ABSTRACT

The invention relates to a method for operating a microwave device (1), the microwave device (1) comprising a cavity (2) and multiple microwave channels (CH1-CH4) for providing microwaves within said cavity (2), the method comprising the steps of: operating one or more microwave channels (CH1-CH4) at one or more first power levels and with varying phases in a data acquisition mode; gathering information regarding channel reverse power (RP) at the one or more microwave channels (CH1-CH4) during said data acquisition mode; establishing a mathematical model for each microwave chan-nel (CH1-CH4) based on said gathered information, said mathematical model providing information regarding channel reverse power (RP) for the respective microwave channel (CH1-CH4); determining operating parameters based on the established mathematical models; and, operating the microwave channels (CH1-CH4) of the microwave device (1) at one or more second power levels based on the determined operation parameters, the power of the second power levels being higher than the power of the first power levels.

The present invention relates generally to the field of microwave devices. More specifically, the present invention relates to a method for operating a microwave device comprising multiple microwave channels.

### BACKGROUND OF THE INVENTION

Microwave devices, specifically microwave ovens, are well-known in prior art. Microwaves used in microwave ovens to heat food have, typically, a frequency of 2.45 GHz. 900 MHz is an alternative frequency used for heating food. The electromagnetic waves produce oscillating magnetic and electric fields that excite water molecules in food, therefore generating heat.

For generating microwave frequency radiation, in a conventional microwave oven, high-voltage is applied to a magnetron. The microwaves are then transmitted through a waveguide to an enclosed cavity containing the load to be heated. The magnetron generates standing wave inside the cavity. Due to the fixed oscillation frequency, typically at 2.45 GHz, the energy pattern inside the microwave oven is fixed. Thus, poor cooking results are achieved because the standing wave leads to so called “hot and cold spots” inside the cavity. To overcome this issue and have more evenness in cooking process, microwave ovens includes additional solutions such as a microwave stirrer and rotating plate.

Microwave ovens using solid state technology introduce the capability to change oscillation frequency and so to vary standing wave and energy pattern inside the cavity. The useage of several microwave channels or microwave modules to direct energy into the cavity through launching devices (antennas, waveguide adapters etc.) enables further control capability. The relative phase changes between active channels lead to standing wave variations so to have different node and antinode configurations and a more uniform energy spread inside the cavity and also within the food.

Document JP2008034244 discloses a microwave treatment device. The document provides for controlling a microwave generating part of the device before the main heating of an object by sweeping frequencies of a microwave generated by the microwave generating part. A relation between the reflection power and the used frequencies is memorized. Then, the main heating of the object is carried out at the frequency at which a minimum reflection power is derived.

Disadvantageously, known methods for determining operation conditions at which the reflected power is reduced, are quite complex and time consuming. Therefore, said methods cannot be performed just before starting the heating process in order to determine a suitable operation condition including the load, because the start of the heating process may be unfavorably delayed.

### SUMMARY OF THE INVENTION

It is an objective of the embodiments of the invention to provide a method for operating a microwave device comprising multiple microwave channels which is configured to determine a suitable working point in a time-effective way. The objective is solved by the features of the independent claims. Preferred embodiments are given in the dependent claims. If not explicitly indicated otherwise, embodiments of the invention can be freely combined with each other.

According to an aspect, the invention refers to a method for operating a microwave device. The microwave device comprises a cavity and multiple microwave channels for providing microwaves within said cavity. The method comprises the steps of:
operating one or more microwave channels at one or more first power levels and with varying phases in a data acquisition mode;
gathering information regarding channel reverse power at the one or more microwave channels during said data acquisition mode;
establishing a mathematical model for each microwave channel based on said gathered information, said mathematical model providing information regarding channel reverse power for the respective microwave channel;
determining operating parameters based on the established mathematical models; and
operating the microwave channels of the microwave device at one or more second power levels based on the determined operation parameters, the power of the second power levels being higher than the power of the first power levels.

Said method is advantageous because only a reduced set of measurements are necessary for establishing the mathematical model and the operating parameters for the heating process (in the following referred to as delivery mode) can be obtained based on said mathematical model with reduced effort.

According to an embodiment, during data acquisition mode, the frequency of said one or more microwave channels is varied, namely by gathering information regarding channel reverse power at different microwave frequencies. Preferably, data acquisition mode is performed using multiple frequency steps, wherein in a certain frequency step, all microwave channels use the same frequency.

According to an embodiment, the step of determining operating parameters comprises choosing the operating parameters such that the channel reverse power for each microwave channel is below a channel reverse power threshold. Thereby, high back reflections which are coupled back into the microwave channel and which may destroy electrical components included in the microwave channel can be avoided.

According to an embodiment, the step of determining operating parameters comprises choosing the operating parameters such that the total reverse power which is the sum of channel reverse power of all microwave channels is below a total reverse power threshold. Thereby the effective power available for heating the load included in the cavity can be increased.

According to an embodiment, said multiple microwave channels are divided into multiple groups. The microwave channels included in a respective group may be linked by common operating parameters or operating parameters that are related with each other due to a certain parameter coefficient. Thereby, the complexity of choosing an appropriate set of operating parameters can be significantly reduced.

According to an embodiment, said groups comprise one master microwave channel and at least one slave microwave channel. The mathematical model may be set up by varying phases of the master channels and the phases of the one or more slave microwave channels associated with a certain master microwave channel may be chosen according to the phase of the master microwave channel.

Thereby the complexity for determining a suitable set of operating parameters can be significantly decreased.

According to an embodiment, the microwave channels of the same group are operated with a fixed phase relationship. “Fixed phase relationship” according to the present disclosure means that the microwave channels of the same group have the same phases or have phases which are linked to each other based on a certain phase constant or phase coefficient. Due to said linkage, only the phases of the master microwave channels are variables and the phases of the slave microwave channels can be derived based on the phase of the associated master microwave channel.

According to an embodiment, the ratio between first power level and second power level is a constant value which is valid for all microwave channels. Thereby, a linear behaviour between the results obtained in data acquisition mode and delivery mode is obtained.

According to an embodiment, a load to be heated is included within the cavity during data acquisition mode. Thereby not only information regarding the empty cavity and its microwave channels is gathered but information regarding the loaded cavity including the object to be heated is obtained which is advantageous for selecting appropriate operating parameters.

According to an embodiment, the mathematical model is established based on a set of curves or a 3D-plot indicating the dependency of the channel reverse power and/or the total reverse power on the phases of the microwaves provided by two or more master microwave channels. Said set of curves or said 3D-plot provides information which phase relationship is suitable for obtaining a reduced channel reverse power (which is at least below a certain threshold value) and/or obtaining a reduced total reverse power.

According to an embodiment, multiple sets of curves or 3D-plots are established, wherein each set refers to a certain microwave frequency. Preferably, all microwave channels are driven with the same frequency and frequency changes are applied to all microwave channels. However, according to other embodiments, it may also be possible to drive the microwave channels with different microwave frequencies.

According to embodiments, the mathematical model is established by determining the mean channel reverse power, maximum channel reverse power and information regarding the phase relation between the phases of two or more master microwave channels. Plotting the channel reverse power over the phases of one or more master microwave channels, the graphical representation of channel reverse power comprises an array of sinusoidal or essentially sinusoidal curves. Said array of sinusoidal or essentially sinusoidal curves can be mathematically described having knowledge of upper-mentioned information. Advantageously, the array of sinusoidal or essentially sinusoidal curves can be gathered by a reduced set of measurements at a reduced power level. Based on said array of sinusoidal or essentially sinusoidal curves, the mathematical model can be established thereby enabling the selection of improved operational parameters.

According to embodiments, the mathematical model uses the following formula for calculating the channel reverse power:

RP(CHₓ)=Mp+Pk·sin(φ_{M2}−Comp_{φ}_{_{M1}});

wherein

Comp_{φ}_{_{M1}}=α·φ_{M1}+β;

Mp is mean channel reverse power received at channel CHₓ;

Pk is the maximum value of the channel reverse power gathered during data acquisition mode;

α is an angular coefficient; and

β is a phase value

According to embodiments, for establishing the mathematical model multiple measurements for gathering information regarding the channel reverse power are performed, wherein the phases of two or more master microwave channels are varied. Thereby, the change of channel reverse power depending on different phase combinations of channel reverse power can be investigated.

According to embodiments, multiple measurements are performed for each microwave channel of the microwave device. Thereby, a set of curves can be established which represents channel reverse power for the respective microwave channel.

According to embodiments, the microwave channels are operated such that the total reverse power and/or the channel reverse power of one or more microwave channels is reduced. Thereby the efficiency of the microwave device is significantly increased.

According to a further aspect, the invention relates to a microwave device. The microwave device comprises a cavity and multiple microwave channels for providing microwaves within said cavity. The microwave device further comprises a control entity configured to perform the following steps:
operating one or more microwave channels at one or more first power levels and with varying phases in a data acquisition mode;
gathering information regarding channel reverse power at the one or more microwave channels during said data acquisition mode;
establishing a mathematical model for each microwave channel based on said gathered information, said mathematical model providing information regarding channel reverse power for the respective microwave channel;
determining operating parameters based on the established mathematical models; and
operating the microwave channels of the microwave device at one or more second power levels based on the determined operation parameters, the power of the second power levels being higher than the power of the first power levels.

The term “essentially” or “approximately” as used in the invention means deviations from the exact value by +/−10%, preferably by +/−5% and/or deviations in the form of changes that are insignificant for the function.

### BRIEF DESCRIPTION OF THE DRAWINGS

The various aspects of the invention, including its particular features and advantages, will be readily understood from the following detailed description and the accompanying drawings, in which:

FIG. 1 shows an example embodiment of a microwave device of solid-state type with multiple microwave channels;

FIG. 2 shows an example implementation of a microwave channel;

FIG. 3 shows a block diagram of a microwave device comprising multiple microwave channels;

FIG. 4a-d show multiple 3-D-plots of channel reverse power of different microwave channels CH1-CH4 over the phases of master channels CH1 and CH2;

FIG. 5 shows a 3-D-plot of total reverse power over the phases of master channels CH1 and CH2;

FIG. 6 shows a 3-D-plot of total reverse power over the phases of master channels CH1 and CH2 with cut-outs of areas in which channel reverse power thresholds are exceeded;

FIG. 7 shows a 2-D-plot of total reverse power over the phases of master channels CH1 and CH2, in which areas of reduced total reverse power are highlighted;

FIG. 8 shows an array of curves showing the total reverse power over the phase of master channel CH2, wherein different curves represent different phases of master channel CH1;

FIG. 9 shows the 3-D-plot of total reverse power according to FIG. 6 including two vertical planes representing two phase values of master channel CH1;

FIG. 10 shows a pair of sinusoidal-like curves of channel reverse power over the phase of master channel CH2;

FIG. 11 shows the 3-D-plot of total reverse power according to FIG. 9 additionally including a horizontal plane representing the mean value of channel reverse power and a dashed line representing the local maxima of total reverse power;

FIG. 12 shows a curve for phase correction;

FIG. 13a-d show multiple sets of 3-D-plots of channel revers power of different microwave channels CH1-CH4 over the phases of master channels CH1 and CH2, wherein the 3-D-plots included in a certain set refer to multiple different frequencies; and

FIG. 14 shows a set of 3-D-plots of total reverse power over the phases of master channels CH1 and CH2 obtained by driving the microwave channels at different frequencies.

### DETAILED DESCRIPTION OF PREFERRED EMBODIMENTS

The present invention will now be described more fully with reference to the accompanying drawings, in which example embodiments are shown. However, this invention should not be construed as limited to the embodiments set forth herein. Throughout the following description similar reference numerals have been used to denote similar elements, parts, items or features, when applicable.

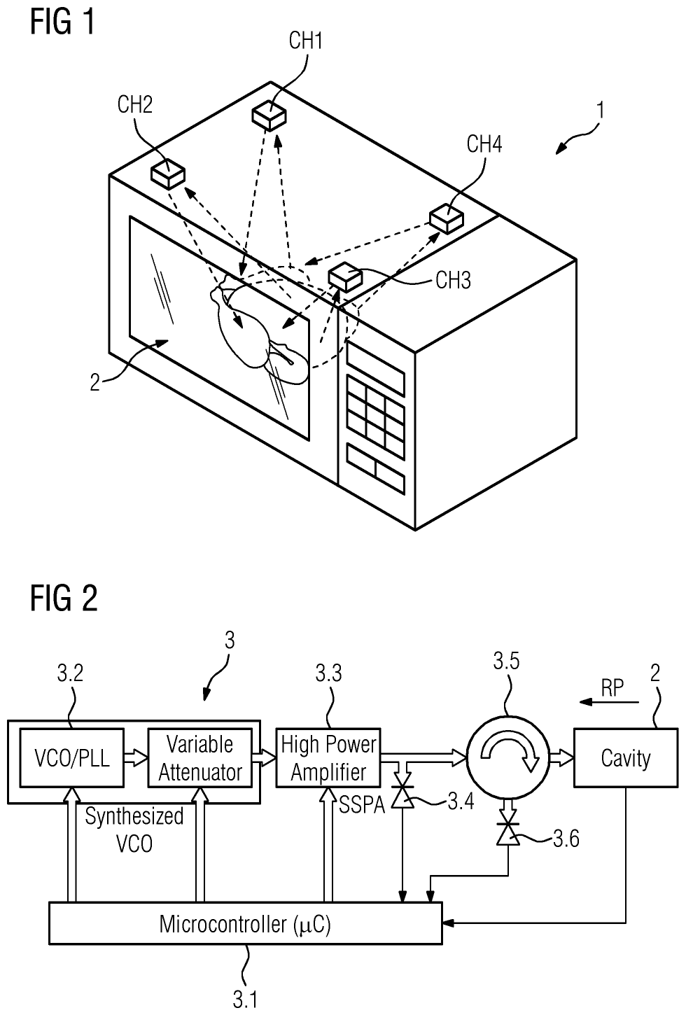

FIG. 1 illustrates a schematic diagram of a microwave device 1. The microwave device 1 may be a microwave oven for heating food. The microwave device 1 comprises a cavity 2. Microwaves can be generated within the cavity 2 by means of microwave channels CH1-CH4. In the present embodiment, the microwave device 1 comprises four microwave channels. However, said number of microwave channels is only a mere example and the invention should not be considered limited to such number of microwave channels. More generally, the microwave device 1 may comprise two or more microwave channels. As already mentioned before, the microwave device 1 may be of solid-state type, i.e. the microwave channels are adapted to change the frequency of provided microwaves in order to vary the energy pattern inside the cavity 2. Said change of frequency leads to variations of the standing wave generated within the cavity 2 and thereby a more uniform energy spread inside the cavity 2 and therefore also inside the load to be heated by microwaves.

FIG. 2 shows an example embodiment of a microwave generator 3, which is coupled with an antenna which provides the microwave into the cavity 2. The microwave generator 3 together with the antenna forms a single microwave channel CH1-CH4.

The microwave generator 3 comprises a control unit 3.1 adapted to control the generation of microwaves. More in detail, the control unit 3.1 may be adapted to influence the frequency, phase and amplitude of the microwave provided into the cavity 2. For example, the microwave generator 3 may comprise a voltage controlled oscillator (VCO) 3.2 which may comprise a phase locked loop (PLL) and an attenuator for generating a HF-signal ways a certain frequency, phase and amplitude. In addition, the microwave generator 3 may comprise an amplifier 3.3 in order to adapt the electric power of the HF-signal.

The control unit 3.1 may be operatively coupled with the voltage controlled oscillator (VCO) 3.2 and the amplifier 3.3 in order to generate an HF-signal with a certain frequency, phase and amplitude as desired.

The output of the amplifier 3.3 may be monitored by a monitoring entity 3.4. More in detail, the monitoring entity 3.4 may comprise a feedback loop which provides a portion of the output signal of the amplifier 3.3 back to the control unit 3.1 or another control entity in order to check whether the output of the amplifier 3.3 fulfils given requirements.

The output of the amplifier 3.3 may further be coupled with a circulator 3.5. The circulator 3.5 may be adapted to forward the HF-signal provided by the amplifier 3.3 towards an antenna (not explicitly shown in FIG. 2) included in the cavity 2. However, the circulator 3.5 is adapted to filter out a reflected HF signal which is provided by the antenna backwards into the microwave generator 3. “Filtering out” in the present case means that the reflected HF signal is blocked from traveling towards the amplifier 3.3 but is directed towards an electrical load 3.6. Said electrical load 3.6 is adapted to consume/absorb the reflected HF signal. Said electrical load 3.6 may be coupled with the control unit 3.1 in order to monitor the consumed/absorbed electric power of the reflected HF signal.

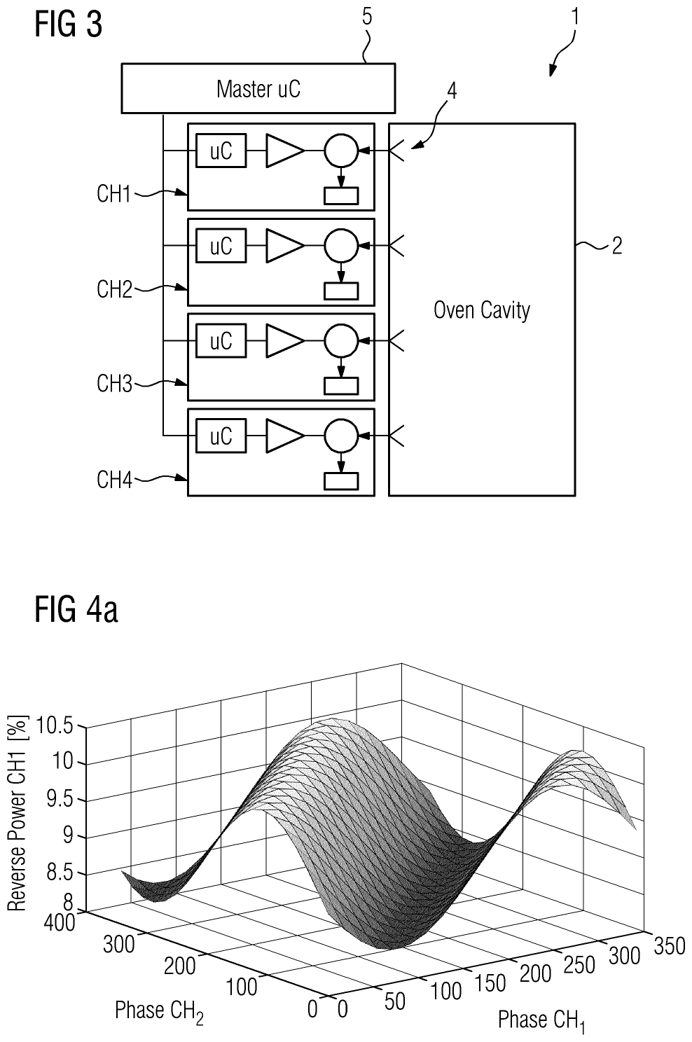

FIG. 3 shows a schematic diagram of the microwave device 1 comprising four microwave channels CH1-CH4. Each microwave channel CH1-CH4 includes a microwave generator 3 as described before in connection with FIG. 2. In addition, each microwave channel CH1-CH4 is coupled with an antenna 4 provided inside the cavity 2. The microwave device 1 further comprises a control entity 5 which is adapted to control the microwave channels CH1-CH4, specifically the microwave generators 3 of the respective microwave channels CH1-CH4, as further described below.

Each microwave generator 3 may be associated with a set of operating parameters which can be chosen in order to achieve a certain microwave transmission behaviour. For example, the frequency of microwaves provided by the microwave generator 3 can be chosen in a certain range, e.g. in the range of 2.4 GHz to 2.5 GHz. The step width may be 100 kHz or any other step width. Preferably, all microwave channels CH1-CH4 are operated at the same frequency, i.e. if the microwave frequency is changed, all channels change their frequency.

In addition, the phase of microwave provided by the microwave channels CH1-CH4 can be varied. For example, one channel may form the reference channel and a phase difference may be chosen between the reference channel and the other microwave channels. The phase difference may be selected in the range of 0° and 359°. The step width of phase difference may be 1° or any other step width.

Furthermore, the electrical power of the microwave provided by the respective microwave channel CH1-CH4 may be a further parameter to be selected. The electrical power may be chosen in the range between 0% and 100%, wherein 0% is power off and 100% is maximum power. The step width of electrical power may be 1% or any other step width.

A further parameter may be microwave channel ON/OFF command.

Each microwave channel CH1-CH4 may further comprise one or more measurement entities, the at least one measurement entity being adapted to measure forward power, i.e. the electric power provided by the respective microwave channel CH1-CH4 into the cavity 2. In addition the same measurement entity or another measurement entity may be adapted to measure reverse power, i.e. the electric power which is received from the cavity 2 by means of the antenna 4 of the respective microwave channel CH1-CH4.

In order to reduce channel reverse power, respectively, total reverse power, operating parameters are determined based on which the microwave device 1, specifically the microwave generators 3 of the microwave channels CH1-CH4 are operated. More in detail, the operating parameters may be chosen such that the channel reverse power for each channel is below a channel reverse power threshold. Said channel reverse power threshold may be chosen such that damage of the microwave generator 3, specifically the load consuming the channel reverse power can be avoided. Alternatively or in addition, the operating parameters may be chosen such that the total reverse power, which may be the sum of channel reverse power of all channels, is below a total reverse power threshold. Thereby the electric power available for heating a load included in the cavity 2 can be maximized and the time span for reaching a certain temperature level at or within the load can be reduced.

Said determination of suitable operating parameters is a complex task because of a plurality of parameters that can be modified in order to achieve a certain technical effect.

The present invention suggests operating the microwave device 1 in a data acquisition mode in order to derive information regarding the channel reverse power RP at a reduced set of operating parameters and set-up a mathematical model based on the information derived during the data acquisition mode in order to determine a suitable set of operating parameters based on said mathematical model. During data acquisition mode, the microwave channels CH1-CH4 are powered at a reduced power level. After determination, said set of operating parameters is used for operating the microwave device 1 at a higher power level in a delivery mode.

In order to reduce the complexity of parameters to be chosen appropriately, the set of microwave channels CH1-CH4, specifically active (i.q. power-on) microwave channels CH1-CH4 is divided into multiple groups or subsets, each subset comprising one master microwave channel and one or more slave microwave channels. For example, in case of four microwave channels CH1-CH4, channels CH1 and CH2 may be master channels, channel CH4 is a slave channel and may be included in a subset together with CH1, whereas CH3 is a slave channel and may be included in a subset together with CH2. So, in other words, CH4 may be a slave channel of CH1 and CH3 may be a slave channel of CH2. It is worth mentioning that upper-mentioned channel grouping is a mere example and also other channel grouping may be possible within the scope of the present invention.

Based on said channel grouping, the following control variables have to be considered:

$$\underline{G} = \{ \begin{matrix}\begin{matrix}{G}_{1} ( Gain Channel 1 ) \\ {G}_{2} ( Gain Channel 2 ) \\ {G}_{3} ( Gain Channel 3 ) \\ {G}_{4} ( Gain Channel 4 )\end{matrix} & \begin{matrix}\underline{{φ}_{G 1}} = \{ \begin{matrix}{φ}_{1} & ( Phase Channel 1 ) \\ {φ}_{4} & ( Phase Channel 4 )\end{matrix} & Group 1 \\ \underline{{φ}_{G 2}} = \{ \begin{matrix}{φ}_{2} & ( Phase Channel 2 ) \\ {φ}_{3} & ( Phase Channel 3 )\end{matrix} & Group 2\end{matrix} & {F}_{1} = {F}_{1} = {F}_{2} = {F}_{3} = {F}_{4}\end{matrix}$$

wherein Gₓ is the gain of the respective channel x, φₓ is the phase of the electromagnetic wave provided at a certain channel x with respect to a reference, and Fₓ is the frequency of the respective channel x. As disclosed before, the frequency of all channels x may be the same, i.e. F=F₁=F₂=F₃=F₄.

The microwave channels of a certain group may be linked with respect to their phase. More specifically, the phase of the slave microwave channel may depend on the phase of the respective master microwave channel according to the following formula:

φ_{slave(i,j)}=φₘₐₛₜₑᵣ₍ⱼ₎+k(i,j)

wherein:

k(i,j) may be a constant value, i is the slave number and j is the group number.

Considering the previous example with four microwave channels CH1-CH4, the phase relationship may be as follows:

$$\begin{matrix}\underline{{φ}_{G 1}} = \{ \begin{matrix}{φ}_{1} \\ {φ}_{4} = {φ}_{1} + {k}_{1}\end{matrix} & Group 1 \\ \underline{{φ}_{G 2}} = \{ \begin{matrix}{φ}_{2} \\ {φ}_{3} = {φ}_{2} + {k}_{2}\end{matrix} & Group 2\end{matrix}$$

k1, k2 may be any value within the range of 0° to 359° and the phase relationship according to k1 and k2 may be used at least in the delivery mode.

Once defined the relation between phases in each channel group, the number of independent variables for phase is equal to the number of channel groups (one for each group).

The method will estimate the channel reverse power in each microwave channel starting from few solutions acquired during data acquisition mode. To perform this task, the gain of microwave channels must be chosen in a proper way. Specifically, the power provided by the microwave channel in the data acquisition mode should be a fraction of the power of the microwave channel in delivery mode. For instance, gains can be selected in a way that each microwave channel CH1-CH4 is delivering a first power level, e.g. 10 W in data acquisition mode and a higher power level in delivery mode, e.g. 200 W. So, in a preferred embodiment, the power ratio between data acquisition mode and delivery mode may be the same for all microwave channels CH1-CH4, in order to obtain a linear behaviour and the same influence of all microwave channels CH1-CH4.

Based on upper-mentioned actuation rules forward channel power and channel reverse power RP can be measured. Said measurement can preferably be performed in real-time. Channel reverse power RP may be represented in general using the following, non-linear set of functions:

$$\{ \begin{matrix}\underline{RP ( {CH}_{1} ) = {Func}_{1} ( \underline{G} , F , {φ}_{1} , … , {φ}_{N} , Load , Antenna … )} \\ \underline{RP ( {CH}_{2} ) = {Func}_{2} ( \underline{G} , F , {φ}_{1} , … , {φ}_{N} , Load , Antenna … )} \\ … \\ \underline{RP ( {CH}_{N} ) = {Func}_{N} ( \underline{G} , F , {φ}_{1} , … , {φ}_{N} , Load , Antenna … )}\end{matrix}$$

where also the load (e.g. food to be heated inside the cavity) and constructive rules (e.g. antenna parameters) are parameters of the equation. Further parameters of the general function are gain G, frequency F, phases of the respective channels φ₁ . . . φ₂.

Taking into account upper-mentioned phase relationship between master and slave channels and an equal gain G on all channels, the set of formulas can be simplified as follows:

$$\{ \begin{matrix}\underline{RP ( {CH}_{1} ) = {Func}_{1} ( G , F , {φ}_{G 1} , {φ}_{G 2} , Load , Antenna … )} \\ \underline{RP ( {CH}_{2} ) = {Func}_{2} ( G , F , , {φ}_{G 1} , {φ}_{G 2} , Load , Antenna … )} \\ … \\ \underline{RP ( {CH}_{N} ) = {Func}_{N} ( G , F , {φ}_{G 1} , {φ}_{G 2} , Load , Antenna … )}\end{matrix}$$

However, the simplification, as explained above, should not deemed to be restrictive for the present invention but the invention can also be applied without said simplifications. Said simplifications are deemed to increase the understanding of the inventive concept.

It is worth mentioning that the calculated values that describe the channel reverse power RP on each channel, take in account the overall system. Due to establishing the mathematical model based on calculated measurements which are load-dependent and system-dependent (i.e. include also the influence of the antennas, the cavity, the temperature, the load etc.), the mathematical model is representative of the effective system currently used. More in detail, the mathematical model takes also into account the status of the food.

In the following, a way to identify the mathematical model represented by Func₁, . . . , Func_{N} is disclosed and how to use said mathematical model to select frequency, amplitude and phases that fulfil wanted constrains in terms of channel reverse power RP and total reverse power (sum of all the channel reverse powers) according to user power requests.

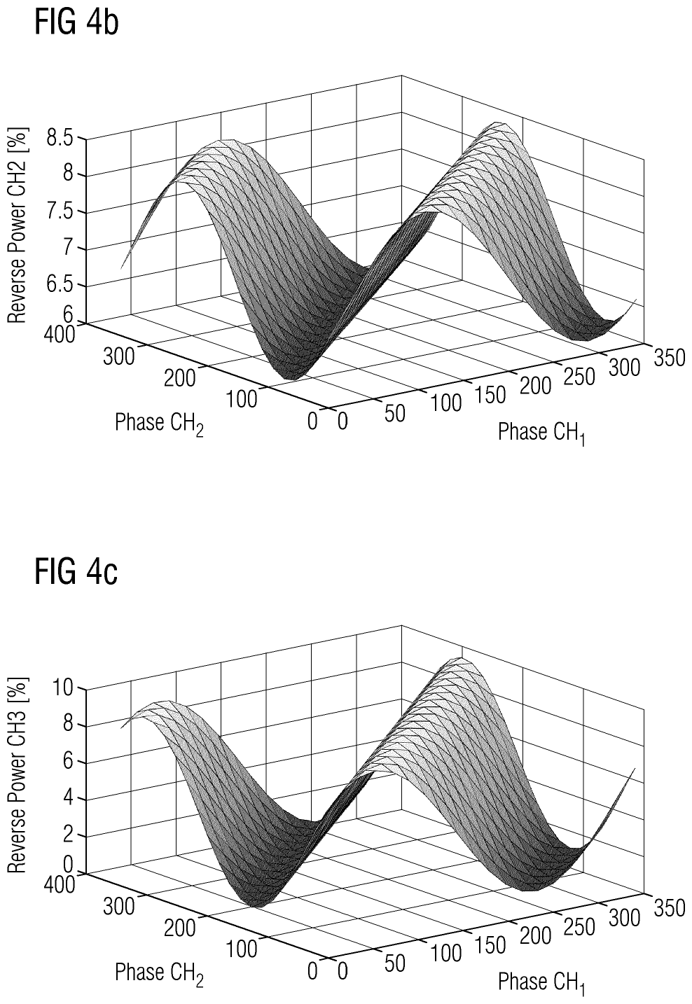

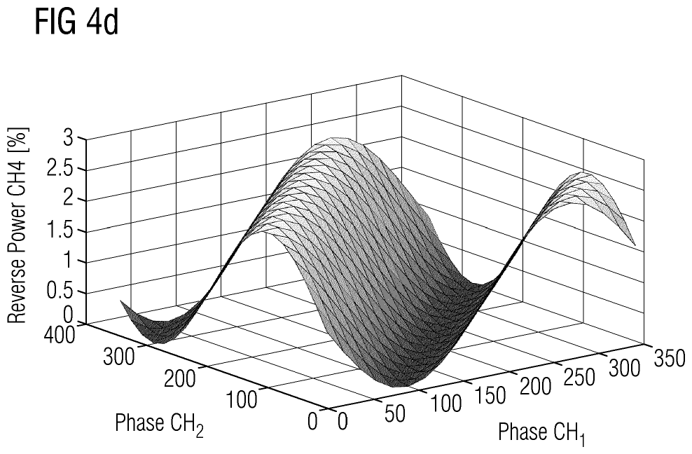

FIGS. 4a to 4d show multiple three-dimensional (3D) plots of channel reverse power RP of the respective microwave channels CH1-CH4 (as percentage values) over the phase of the microwave of a first master microwave channel CH1 and a second master microwave channel CH2. The percentage value may indicate which fraction of channel power provided by a certain microwave channel or multiple microwave channels is reflected back into the microwave generator. The values of channel reverse power RP are obtained during data acquisition mode using low-power microwaves, changing the microwave phases of master channels CH1 and CH2 in a certain value range and measuring the channel reverse power RP which is received by the respective antenna of the channel.

Said 3D-plots show that the channel reverse power RP is strongly dependent on the absolute values and relative values of phases of the master microwave channels. For example, FIG. 4a shows that a minimum of channel reverse power RP can be obtained for phase values of channel CH1 in the area of 100° and for phase values of channel CH2 in the area of 125°. However, the channel reverse power RP has a maximum for phase values of channel CH2 in the area of 300° and keeping the phase of channel CH1 in the area of 100°.

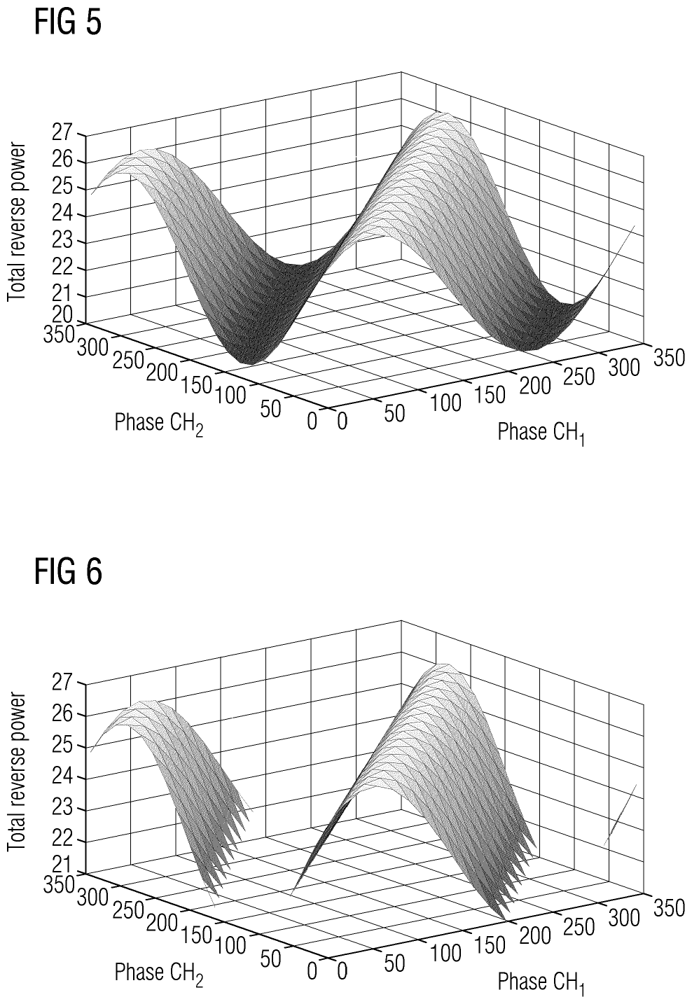

FIG. 5 shows the total reverse power which is the sum of all channel reverse powers shown in FIGS. 4a to 4d. Similar to the channel reverse power plots, also the total reverse power plot shows maxima and minima at certain phase combinations.

By introducing certain channel reverse power constraints, the value range, in which operating parameters, specifically phases of master channels can be chosen, can be restricted. For example, FIG. 6 shows a 3D plot similar to FIG. 5, in which certain plot portions are cutted-out in order to fulfil the requirement that the channel revers power RP for each microwave channel CH1-CH4 should be lower than 10%. So, the remaining portions of the 3D-plot fulfil upper-mentioned requirement, i.e. when selecting a pair of phases for which a value is included in the plot, the channel revers power RP for each microwave channel CH1-CH4 is lower than 10%.

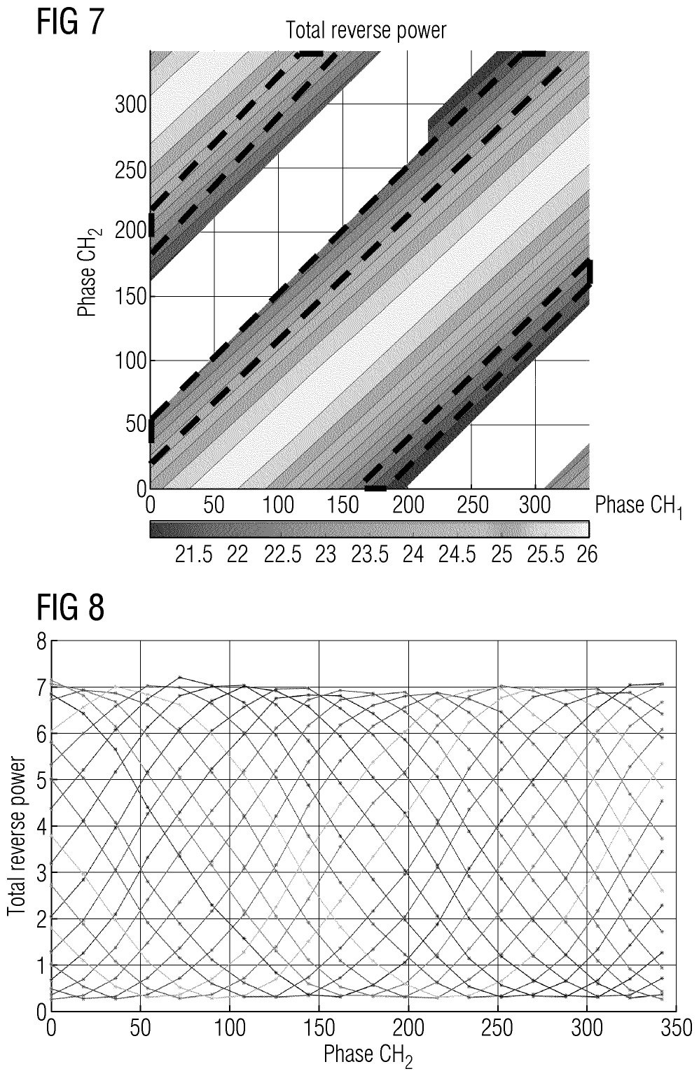

FIG. 7 shows a planar plot of the 3D-plot of FIG. 6, in which phase areas are identified (by means of dashed lines) which lead to a reduced total reverse power. So, using phase pairs located within said highlighted areas lead not only to channel revers power values lower than 10% but also a maximization of effective microwave power provided to the cavity 2. So, based on the information of FIGS. 6 and/or 7 it is possible to determine suitable phase pairs for the master channels. Using upper-mentioned relationship between phases of master channel and slave channel of a certain channel group it is possible to determine the phases of the other (slave) channels.

In the following, it is disclosed how to establish the mathematical model based on information gathered during data acquisition mode.

First, after channel grouping and determining a master channel in each group, data acquisition mode is performed. More in detail, for one or more frequencies, the phases of master channels are varied and channel reverse power, respectively, total reverse power is measured. More in detail, the phase of a first master channel may be varied preferably through the whole phase range from 0° to 359° (e.g. stepwise increased/decreased) whereas the phase of the other master channel is kept constant.

After determining the phase-dependent channel reverse power RP in each channel, the phase of the other master channel (which has been constant before) is increased/decreased by a certain phase step and the phase of the first master channel is varied again, preferably through the whole phase range from 0° to 359°. Thereby, discrete channel reverse power RP information as shown in FIGS. 4a to 4d are obtained. Based on said channel reverse power RP information, the phase-dependent total reverse power can be calculated by summing-up channel reverse power values at certain phase values of the master channels.

FIG. 8 shows an array of curves, wherein the x-axis (i.e. the horizontal axis) shows the phase of a second master channel Ch2 and the y-axis (vertical axis) shows a channel reverse power as a percentage value. Each curve of the curve array relates to a different phase of the first master channel CH1.

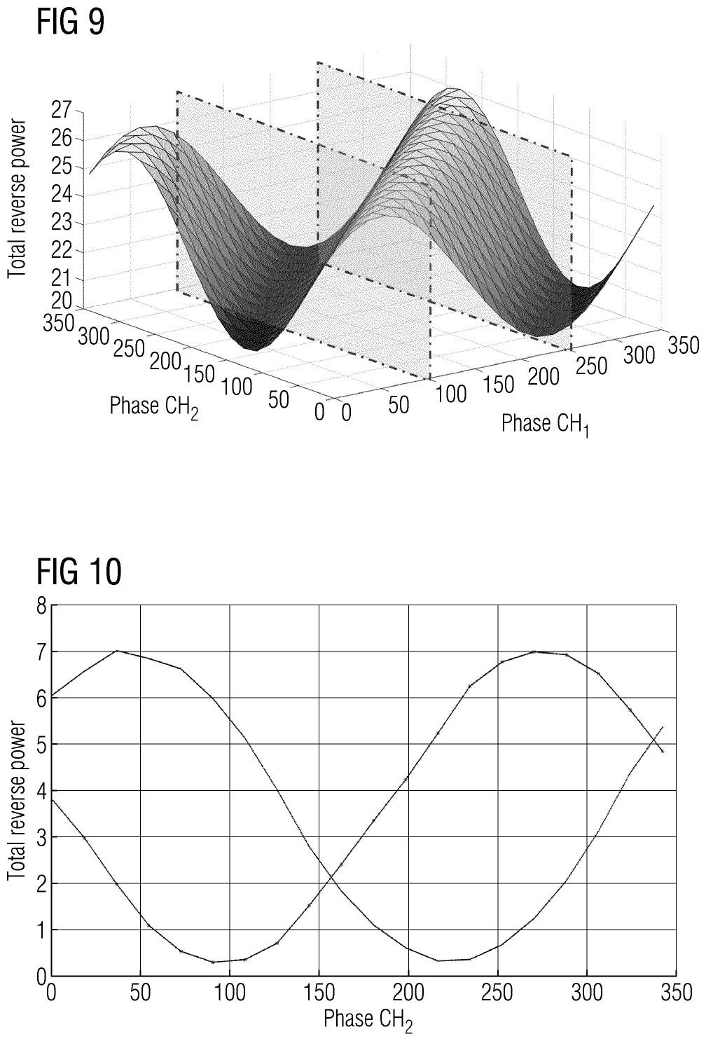

FIG. 9 shows the total reverse power as a 3D-plot which is created by summing-up channel reverse power values of channels CH1-CH4 belonging to the same pair of phase values. FIG. 10 shows the graphs at a pair of fixed phase values of channel CH1 as depicted by the vertical planes included in FIG. 9.

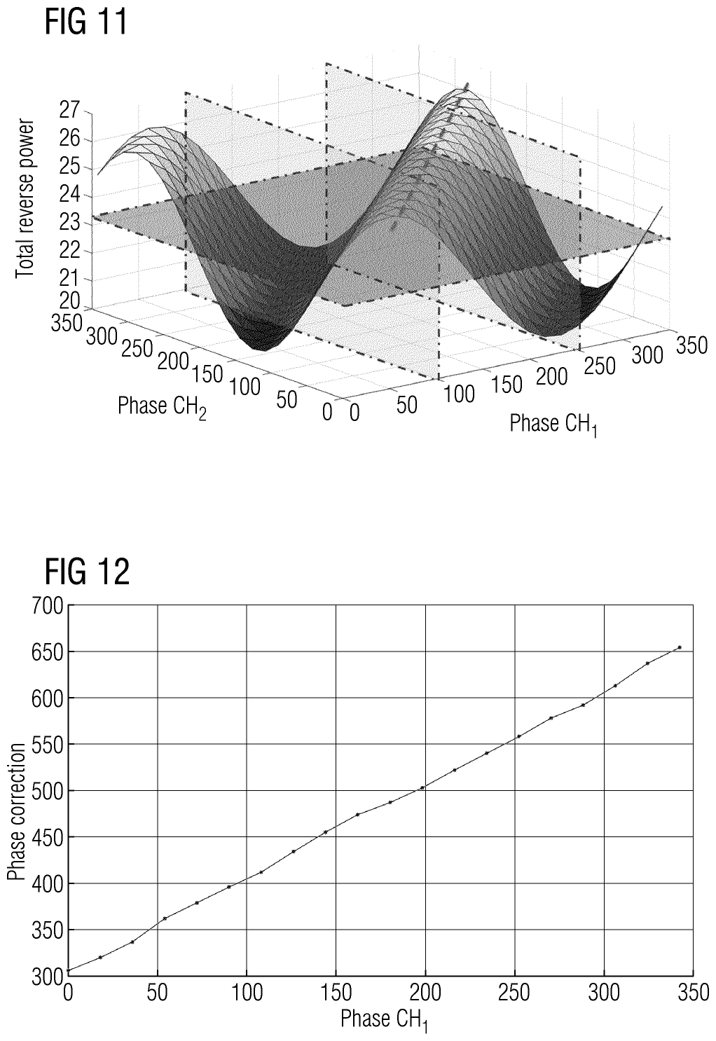

FIG. 11 shows the plot of FIG. 9, in which a horizontal plane is included which is arranged at a mean value between maximum and minimum values of total reverse power plot. In addition, FIG. 11 shows a dashed line which coincides with the maximum peak values of the total reverse power plot.

Due to the fact, that the slices as indicated by the vertical planes in FIG. 11 lead to sine functions (cf. FIG. 10), the channel reverse power RP of a certain channel CHx can be expressed by the following function:

$$\{ \begin{matrix}RP ( CHx ) = Mp + Pk * Sin ( {φ}_{M 2} - Comp ( {φ}_{M 1} ) ) \\ Comp ( {φ}_{M 1} ) = α * {φ}_{M 1} + β\end{matrix}$$

wherein

Mp is the mean value of channel reverse power RP (indicated by the horizontal plane);

Pk is the amplitude of the sine function;

φ_{M1,M2} are the phase values of first and second master channels;

α is an angular coefficient indicating the slanting of the dashed line in FIGS. 11; and

β indicates the value of φ_{M2} at the point of intersection between the φ_{M2}-axis and the dashed line in FIG. 11.

It is worth mentioning that Mp, Pk, α and β are dependent on the information gathered during data acquisition mode and are specific for the respective channel.

FIG. 12 illustrates phase correction values by considering the phase of CH A.

According to an example, the following measurements may be performed in order to set-up the mathematical model:

| φ_{M1} [°] | φ_{M2} [°] | RP% CHx |
|---|---|---|
| 90 | 90 | RP₁ |
| 90 | 180 | RP₂ |
| 90 | 270 | RP₃ |
| 180 | 90 | RP₄ |
| 180 | 180 | RP₅ |
| 180 | 270 | RP₆ |

Based on the gathered channel reverse power values RP₁ . . . RP₃ and RP₄ . . . RP₆ associated with the preceding phase tuples, the sine function shown in FIG. 10 (slices of the 3D-plot of FIG. 9 at the vertical planes) can be reconstructed. Based on the sinusoidal parameters on the two planes, α and β can be calculated. The mathematical model has to be established for each channel CH1-CH4. During delivery mode, the phase of the slave channels must be related to the phase of the master channels as described before.

Having a system with four channels we need at least 24 measurement data (or 6 measure points for each channel) for reconstructing the representations according to FIGS. 4a-4d and FIG. 5.

In case that the microwave channels CH1-CH4 should be driven with different frequencies, for each frequency a mathematical model as described before has to be established.

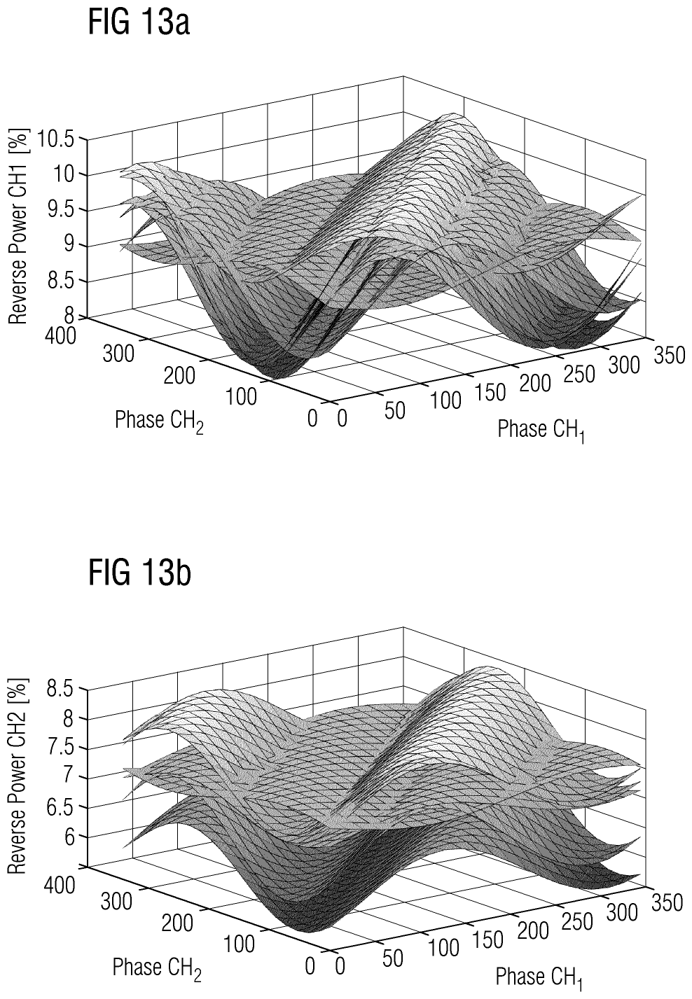

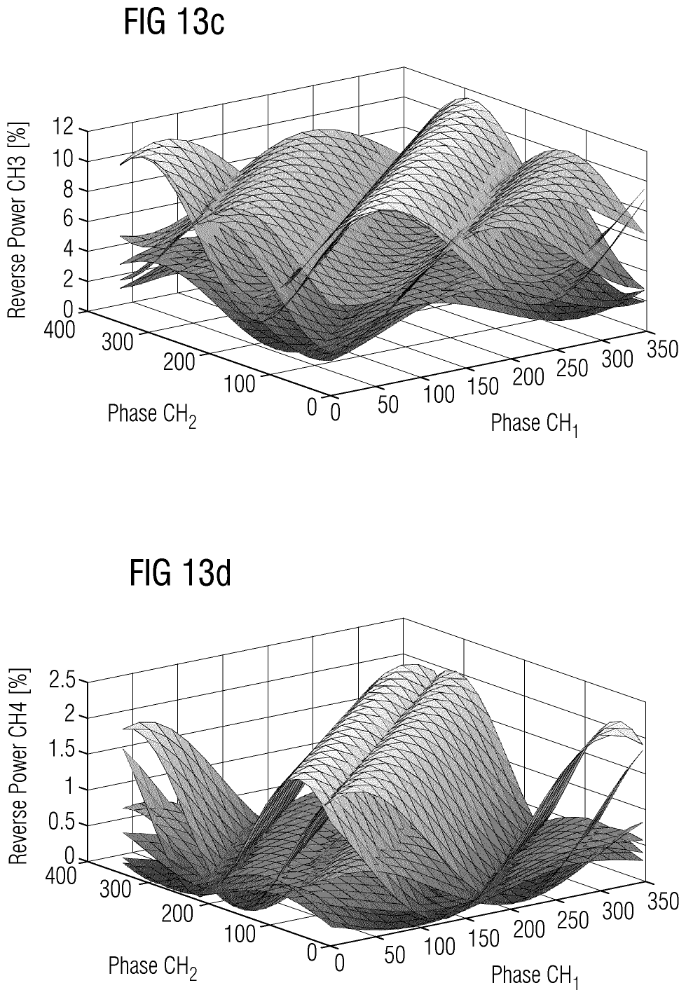

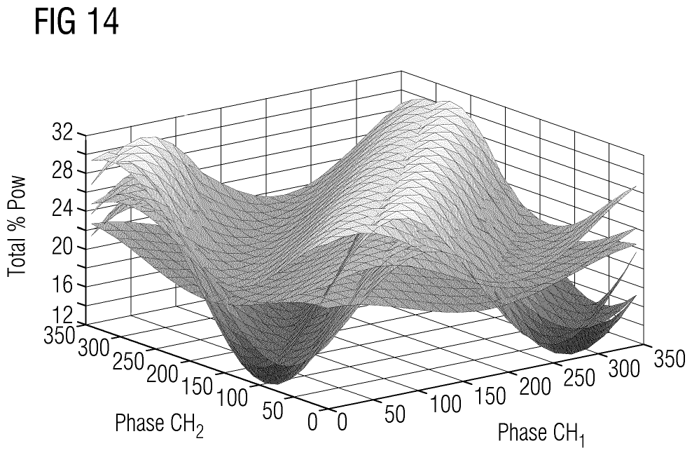

FIGS. 13a to 13d and FIG. 14 show the channel reverse power, respectively, the total reverse power for different frequencies. It is worth mentioning that the channel reverse power strongly depends on the chosen frequency. Therefore, before operating the microwave device 1, the frequency, respectively, the frequency range in which the microwave device 1 is driven, should be specified.

It should be noted that the description and drawings merely illustrate the principles of the proposed invention. Those skilled in the art will be able to implement various arrangements that, although not explicitly described or shown herein, embody the principles of the invention.

### LIST OF REFERENCE NUMERALS

1 microwave device

2 cavity

3 microwave generator

3.1 control unit

3.2 voltage controlled oscillator

3.3 amplifier

3.4 monitoring entity

3.5 circulator

3.6 electrical load

4 antenna

5 control entity

CH1-CH4 microwave channel

RP channel reverse power

1. Method for operating a microwave device, the microwave device comprising a cavity and multiple microwave channels for providing microwaves within said cavity, the method comprising the steps of:
operating one or more of the microwave channels at one or more first power levels and with varying phases in a data acquisition mode;
gathering information regarding channel reverse power at the one or more microwave channels during said data acquisition mode;
establishing a mathematical model for each said microwave channel based on said gathered information, said mathematical model providing information regarding channel reverse power for the respective microwave channel
determining operating parameters based on the established mathematical models; and
operating the microwave channels of the microwave device at one or more second power levels based on the determined operating parameters, the second power levels being higher than the first power levels.

2. Method according to claim 1, wherein the step of determining operating parameters comprises choosing the operating parameters such that the channel reverse power for each said microwave channel is below a channel reverse power threshold.

3. Method according to claim 1, wherein the step of determining operating parameters comprises choosing the operating parameters such that total reverse power, which is the sum of the channel reverse power (RP) of all said microwave channels-, is below a total reverse power threshold.

4. Method according to claim 1, wherein said multiple microwave channels are divided into multiple groups.

5. Method according to claim 4, wherein each said group comprises one master microwave channel and at least one slave microwave channel.

6. Method according to claim 4, wherein the microwave channels of the same group are operated with a fixed phase relationship.

7. Method according to claim 1, wherein a ratio between the one or more first power levels and the one or more second powers level is a constant value which is valid for all microwave channels.

8. Method according to claim 1, wherein a load to be heated is included within the cavity during said data acquisition mode.

9. Method according to claim 5, wherein the mathematical model is established based on a set of curves or a 3D-plot indicating dependency of the channel reverse power and/or the total reverse power on phases of microwaves provided by two or more said master microwave channels.

10. Method according to claim 9, wherein the mathematical model is established by determining a mean channel reverse power, a maximum channel reverse power and information regarding a phase relation between the phases of the microwaves provided by the two or more said master microwave channels.

11. Method according to claim 1, wherein the mathematical model uses the following formula for calculating the channel reverse power:
RP(CHₓ)=Mp+Pk·sin(φ_{M2}−Comp_{φ}_{_{M1}});
wherein
Comp_{φ}_{_{M1}}=α·φ_{M1}+β;
Mp is mean channel reverse power received at channel CHₓ;
Pk is a maximum value of the channel reverse power gathered during said data acquisition mode;
α is an angular coefficient; and
β is a phase value.

12. Method according to claim 5, wherein for establishing the mathematical model multiple measurements for gathering information regarding the channel reverse power are performed wherein the phases of two or more said master microwave channels are varied.

13. Method according to claim 12, wherein multiple measurements are performed for each microwave channel of the microwave device.

14. Method according to claim 1, wherein the microwave channels are operated such that a total reverse power, which is the sum of the channel reverse power (RP) of all said microwave channels, is minimized and/or the channel reverse power of one or more said microwave channels is reduced.

15. Microwave device comprising a cavity and multiple microwave channels for providing microwaves within said cavity, wherein the microwave device comprises a control entity, the control entity being configured to perform the following steps:
operating one or more of said microwave channels at one or more first power levels and with varying phases in a data acquisition mode;
gathering information regarding channel reverse power at the one or more microwave channels during said data acquisition mode;
establishing a mathematical model for each said microwave channel based on said gathered information, said mathematical model providing information regarding channel reverse power for the respective microwave channel;
determining operating parameters based on the established mathematical models; and
operating the microwave channels of the microwave device at one or more second power levels based on the determined operation parameters, the second power levels being higher than the first power levels.

16. Method for operating a microwave device comprising a cavity and multiple microwave channels for providing microwaves within said cavity, the method comprising:
in a first mode, and with a food load disposed within the cavity:
operating one or more of the microwave channels to generate microwaves at a first power level across a plurality of phases;
collecting reverse power values for each of the one or more microwave channels at said first power level and across said plurality of phases, wherein the respective reverse power values are dependent at least in part on said food load;
establishing one or more mathematical models, respectively, for the one or more microwave channels based on the respective reverse power values for each said microwave channel; and
from the established mathematical models, determining operating parameters for the one or more microwave channels, such that the determined operating parameters correspond to: i) a minimum said reverse power value for at least one said microwave channel, or ii) a minimum total reverse power value calculated as the sum of all the reverse power values of said one or more microwave channels; and
in a second mode, cooking said food load within the oven cavity by operating said one or more microwave channels according to the determined operating parameters and at a second power level higher than the first power level.

17. Method according to claim 16, wherein each said mathematical model is based on the following formula:
RP(CHₓ)=Mp+Pk·sin(φ_{M2}−Comp_{φ}_{_{M1}});
wherein
RP(CHₓ) is the reverse power of of a particular microwave channel CHₓ
Comp_{φ}_{_{M1}}=α·φ_{M1}+β;
Mp is mean channel reverse power received at channel CHₓ;
Pk is a maximum value of the channel reverse power gathered during the data acquisition mode;
φ_{M1} and φ_{M2} are phase values of first and second master microwave channels, M1 and M2, from among said one or more microwave channels;
α is an angular coefficient;
β is a value of φ_{M2} at a point of intersection between a φ_{M2} axis and a line coinciding with maximum peak values of total reverse power in a 3D plot thereof as a function of φ_{M1} and φ_{M2}.

18. Method according to claim 17, said one or more microwave channels being divided into at least a first group comprising said first master microwave channel M1 and a first slave microwave channel, and a second group comprising said second master microwave channel M2 and a second slave microwave channel, wherein the microwave channels of the same group are operated according to a fixed phase relationship during both the first mode and the second mode.
